(19) United States
(12) Patent Application Publication
(10) Pub. No.: US 2005/0013285 A1
(43) Pub. Date: Jan. 20, 2005

(54) Optimal routing when two or more network elements are integrated in one element

(76) Inventor: Iikka Westman, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/479,051

(22) PCT Filed: May 28, 2001
(86) PCT No.: PCT/EP01/06069

(51) Int. Cl. H04L 12/28; H04L 12/66

(52) U.S. Cl. 370/351; 370/401

(57) ABSTRACT

A call is routed between at least two logical network elements each performing a logical functionality on the call, the logical functionalities of the at least two logical network elements being accommodated in one physical control entity in an IP communication network system. When a call is received at the physical control entity as a first logical functionality, call-related processing is performed in the physical control entity as the first logical functionality, thereby obtaining a content of a first data structure. Then, a second logical functionality is invoked in the physical control entity, wherein the content of the first data structure is supplied inside the physical control entity to a second data structure of the second logical functionality so that the content of the second data structure is substantially similar too a content obtained at the same stage in said second logical functionality by external routing between logical network elements.

### FIELD OF THE INVENTION

The present invention relates to All-IP (All-Internet Protocol) communication systems, and in particular to routing between network elements, such as CSCFs (Call State Control Functions), BGCFs (Breakout Gateway Control Functions) and MGCFs (Media Gateway Control Functions), when two or more of these network elements are the same element.

### BACKGROUND OF THE INVENTION

There are different kinds of network elements participating in a call setup. For example, FIG. 1 shows a call-setup between subscriber A and B via an originating P-CSCF (Proxy Call State Control Function), originating S-CSCF (Serving Call State Control Function), I-CSCF (Interrogating Call State Control Function), terminating S-CSCF and terminating P-CSCF. These network elements can be seen as logical functionalities instead of actual physical CSCFs. One physical CSCF may accommodate two or more of these functionalities in the set-up of one call.

Normally, two CSMs (Call State Models), an O-CSM (Originating CSM) and a T-CSM (Terminating CSM), are needed in every CSCF, BGCF (Breakout Gateway Control Function) or MGCF network element to handle a single call from subscriber A to subscriber B where the logical functionalities of the originating operator could be e.g. P-CSCF, S-CSCF, I-CSCF, S-CSCF and P-CSCF; or P-CSCF, S-CSCF, BGCF and MGCF, and the logical functionalities of the terminating operator could be e.g. MGCF, I-CSCF, S-CSCF and P-CSCF; or BGCF and MGCF. CSM has one or more states. In case at least two of the network elements in question are the same element, i.e. one physical network element accommodates two or more logical functionalities in the set-up of one call, the set-up is done via an external loopback ME1 from a T-CSM to an O-CSM as shown in FIG. 7. No care is taken as to whether the network elements are the same element, and the signaling is conducted always through an interface between two network elements.

An example for this prior art solution is given in FIG. 8. According to FIG. 8, logical functionalities P-CSCF and S-CSCF are used as example of the two logical functionalities that are located in the same network element called here P-CSCF/S-CSCF. Originated and terminated call state models (i.e. O-CSM and T-CSM) of a logical functionality are separated. SIP is used as NNI (Network to Network Interface) protocol i.e. as protocol that is used between network elements. An originating call case where P-CSCF and S-CSCF are located in the same network is used as an example.

As it is shown in FIG. 8, when a terminal A wants to invite another party to a session, in a step 801, it sends an INVITE message to the P-CSCF/S-CSCF network element. Then, in a step 802, Call control signaling adaptation transforms the INVITE message to the internal format of the call control and stores it to an internal data structure.

In a step 803, the content of the internal data structure is passed as data to an O-CSM of the P-CSCF. The O-CSM stores the data to an internal data structure in a step 804, and handles its content. In a step 805, the O-CSM passes the control and the handled data in the internal data structure to a T-CSM of the P-CSCF. The T-CSM stores the data to an internal data structure in a step 806, and handles its content.

In a step 807, the content of the internal data structure is passed to Call control signaling adaptation. Call control signaling adaptation stores the data to an internal data structure and transforms its content to an INVITE message in a step 808. DNS (Domain Name Server) resolving is used to find out the IP address of the next network element. In a step 809, an INVITE message is sent from the-P-CSCF to an S-CSCF via external routing.

This INVITE message is received by an S-CSCF the functionality of which is located in the same network element P-CSCF/S-CSCF. In a step 810, Call control signaling adaptation transforms the INVITE message to the internal format of the call control and stores it to an internal data structure.

In a step 811, the content of the internal data structure is passed as data to an O-CSM of the S-CSCF. The O-CSM stores the data to an internal data structure in a step 812, and handles its content. In a step 813, the O-CSM passes the control and the handled data in the internal data structure to a T-CSM of the S-CSCF. The T-CSM stores the data to an internal data structure in a step 814, and handles its content.

In a step 815, the content of the internal data structure is passed to Call control signaling adaptation. Call control signaling adaptation stores the data to an internal data structure and transforms its content to an INVITE message in a step 816. DNS resolving is used to find out the IP address of the next network element. In a step 817, an INVITE message is sent from the S-CSCF to an I-CSCF via external routing.

### SUMMARY OF THE INVENTION

It is an object of the present invention to optimize routing when two or more network elements are the same element on a signaling path.

According to the present invention, this object is achieved by routing a call between at least two logical network elements each performing a logical functionality on the call, the logical functionalities of the at least two logical network elements being accommodated in one physical control entity in an IP communication network system. When a call is received at the physical control entity as a first logical functionality, call-related processing is performed in the physical control entity as the first logical functionality, thereby obtaining a content of a first data structure. Then, a second logical functionality is invoked in the physical control entity, wherein the content of the first data structure is supplied inside the physical control entity to a second data structure of the second logical functionality so that the content of the second data structure is substantially similar to a content obtained at the same stage in said second logical functionality by external routing between logical network elements.

“Substantial similarity” between two contents of data structures means, for example, that the data structures are similar enough to avoid the introduction of significantly different program codes for the processing of the contents.

According to a first embodiment of the present invention, the content of the first data structure is supplied within one call state model for a beginning of a functionality and an ending of a functionality.

According to a second embodiment of the present invention, the content of the first data structure is supplied by sending a message inside the physical control entity from a call state model for an ending of a functionality to a call state model for a beginning of a functionality.

According to a third embodiment of the present invention, the content of the first data structure is supplied by sending a first message from a call state model for an ending of a functionality to a first adapter process for translating the content of the first data structure to a data structure of an inter network element sending signaling, sending a second message from the first adapter process to a second adapter process for supplying the content of the inter network element sending signaling data structure to a data structure of an inter network element receiving signaling, so that the content of the inter network element receiving signaling data structure is substantially similar to a content obtained at the same stage in said second adapter process by external routing between logical network elements, and sending a third message from the second adapter process to a call state model for a beginning of a functionality, for translating the content of the inter network element receiving signaling data structure to the second data structure.

According to a fourth embodiment of the present invention, the content of the first data structure is supplied by sending a first message from a call state model for an ending of a functionality to a first adapter process for translating the content of the first data structure to a data structure of an inter network element sending signaling, performing processing on the content of the inter network element sending signaling data structure, thereby obtaining a content of a processed inter network element sending signaling data structure, sending a second message from the first adapter process to a second adapter process for supplying the content of the processed inter network element sending signaling data structure to a data structure of a processed inter network element receiving signaling, so that the content of the processed inter network element receiving signaling data structure is substantially similar to a content obtained at the same stage in said second adapter process by external routing between logical network elements, performing processing on the content of the processed inter network element receiving signaling data structure, thereby obtaining a content of an inter network element receiving signaling data structure and sending a third message from the second adapter process to a call state model for a beginning of a functionality, for translating the content of the inter network element receiving signaling data structure to the second data structure.

According to a fifth embodiment of the present invention, the content of the first data structure is supplied by sending a first message from a call state model for an ending of a functionality to a first adapter process for translating the content of the first data structure to a data structure of an inter network element sending signaling, performing processing on the content of the inter network element sending signaling data structure, thereby obtaining a content of a processed inter network element sending signaling data structure, performing looping from the first adapter process to a second adapter process via a protocol level below the used signaling protocol between network elements for supplying the content of the processed inter network element sending signaling data structure to a data structure of a processed inter network element receiving signaling, so that the content of the processed inter network element receiving signaling data structure is substantially similar to a content obtained at the same stage in said second adapter process by external routing between logical network elements, performing processing on the content of the processed inter network element receiving signaling data structure, thereby obtaining a content of an inter network element receiving signaling data structure and sending a third message from the second adapter process to a call state model for a beginning of a functionality, for translating the content of the inter network element receiving signaling data structure to the second data structure.

According to the first embodiment, an extremely efficient use of messages and processes is achieved, i.e. the number of messages and processes can be reduced significantly compared with an external loopback. Moreover, an efficient use of bandwidth can be obtained.

According to the second embodiment, messages and processes can be used very efficiently. Further, an efficient use of bandwidth is achieved.

According to the third embodiment, messages, processes and bandwidth can be used efficiently. Moreover, a clean CSM is provided.

According to the fourth embodiment, an efficient use of bandwidth is achieved and CSM is kept clean.

According to the fifth embodiment, bandwidth is used efficiently.

In the following the present invention will be described by way of preferred embodiments thereof with reference to the accompanying drawings.

### BRIEF DESCRIPTION OF THE DRAWINGS

FIG. 1 shows a schematic block diagram of a signaling path when subscriber A makes a call to subscriber B and both subscribers are located in the same network.

FIG. 2 shows a schematic block diagram according to a control entity of a first embodiment of the present invention.

FIG. 3 shows a schematic block diagram according to a control entity of a second embodiment of the present invention.

FIG. 4 shows a schematic block diagram according to a control entity of a third embodiment of the present invention.

FIG. 5 shows a schematic block diagram according to a control entity of a fourth embodiment of the present invention.

FIG. 6 shows a schematic block diagram according to a control entity of a fifth embodiment of the present invention.

FIG. 7 shows a schematic block diagram of a solution according to the prior art.

FIG. 8 shows an example of the prior art solution.

FIG. 9 shows an example of the solution according to the first embodiment.

FIG. 10 shows an example of the solution according to the second embodiment.

FIG. 11 shows an example of the solution according to the third embodiment.

FIG. 12 shows an example of the solution according to the fourth embodiment.

FIG. 13 shows an example of the solution according to the fifth embodiment.

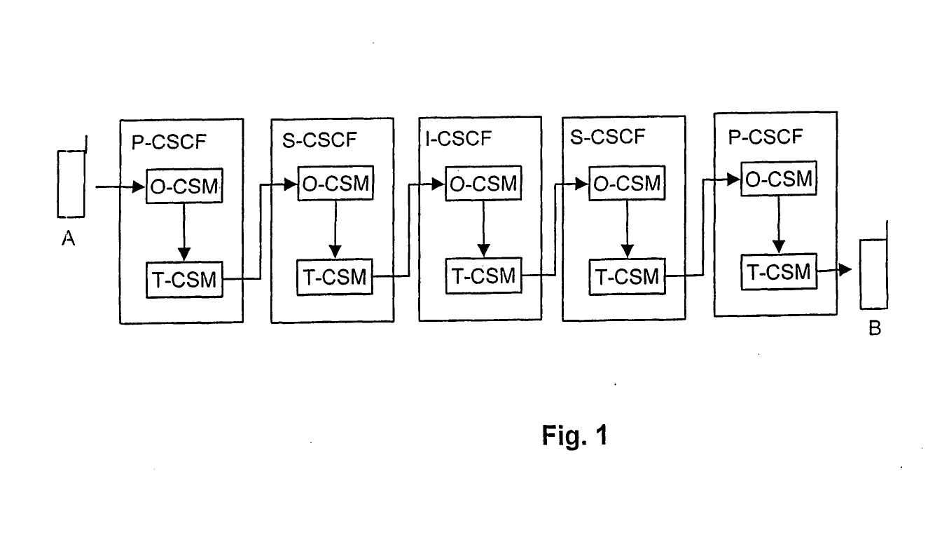

### DESCRIPTION OF THE PREFERRED EMBODIMENTS

The idea of the present invention is to route outgoing signaling internally in a control entity accommodating two or more logical functionalities of different logical network elements. For example, the respective functionality of a calling S-CSCF (Serving CSCF) and a called I-CSCF and possibly also of a called S-CSCF may be performed in the same physical CSCF. For instance, the S-CSCF must inspect the logical address e.g. FQDN (Fully Qualified Domain Name) or an IP (Internet Protocol) address obtained by performing a DNS (Domain Name Server) resolution procedure to check whether it refers to an own network. In that case, the S-CSCF may perform an I-CSCF functionality (e.g. a called party S-CSCF search), and then it may invoke a logical called party S-CSCF functionality, if the logical address or the returned IP address refers to the same node.

In the present context, a call refers to any multimedia sessions in addition to voice calls, e.g. video calls.

It is to be noted that a call state control function is not necessarily just a CSCF in accordance with 3GPP specifications. For instance, it can also be a call processing server in accordance with IETF session initiation protocol RFC 2543. It can also be a gatekeeper in accordance with ITU-T H.323 specifications. It can be any call processing server or call state control function performing call signaling related tasks.

The present invention is not bound to any specific NNI (Network to Network Interface) protocol. The messages described in the embodiments may reside on call control level, SIP (Session Initiation Protocol) level or TCP/UDP (Transmission Control Protocol/User Datagram Protocol) level, for example.

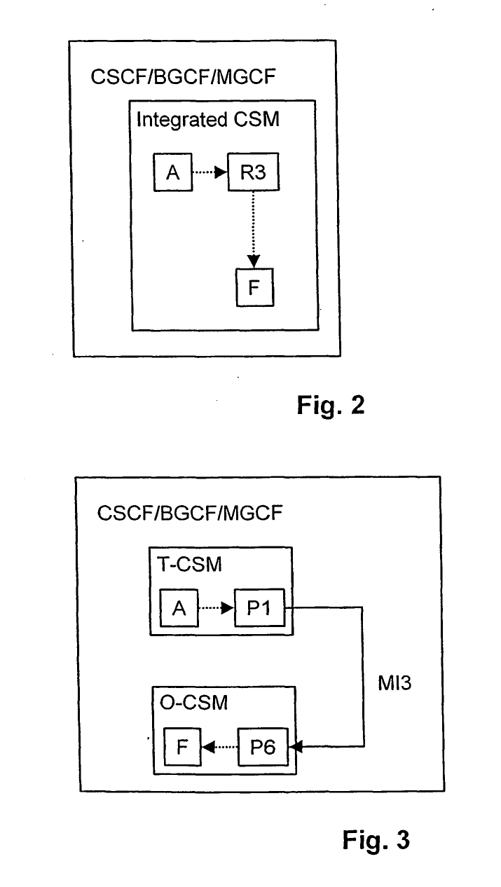

Throughout FIGS. 2 to 7, merely a T-CSM of a first logical functionality and an O-CSM of a second logical functionality are illustrated. The O-CSM of the first and the T-CSM of the second logical functionality are not shown.

FIG. 2 shows a schematic block diagram according to a control entity of a first embodiment. A control entity accommodating two or more logical functionalities of network elements on a signaling path is represented by a CSCF, BGCF or MGCF. According to the first embodiment, one integrated CSM (Call State Model) is used that contains the functionality to route outgoing signaling internally in the CSCF/BGCF/MGCF. The integrated CSM combines both functionalities of an originating CSM and a terminating CSM. When signaling has to be performed from one logical network element to another, this signaling is done internally in the integrated CSM in the CSCF/BGCF/MGCF by a process R3 processing the content of a data structure A. As a processing result, a content of a data structure F is obtained which is substantially similar to a content as if the signaling was conducted externally from a terminating CSM to an originating CSM. The broken lines in FIG. 2 and in the following figures represent an input/output of data.

FIG. 3 shows a schematic block diagram according to a second embodiment. The second embodiment differs from the first embodiment in that a CSCF/BGCF/MGCF accommodating two or more logical funtionalities of different logical network elements comprises an originating CSM and a terminating CSM. The terminating CSM sends a signaling message MI3 directly to the originating CSM inside the CSCF/BGCF/MGCF. The message MI3 carries the content of the data structure A to the data structure F so that the content of F is substantially similar to a content of F as if the message path was an external path between logical network elements. A process P1 on the data of

A is needed for sending the message MI3 from the terminating CSM, and a process P6 is needed when the message is received at the originating CSM in the CSCF/BGCF/MGCF. For example, when SIP is used, the process P6 may add the FQDN (Full Qualified Domain Name) of a network element corresponding to the originating CSM functionality receiving the message to a Record-Route header, but may add nothing to the Via header.

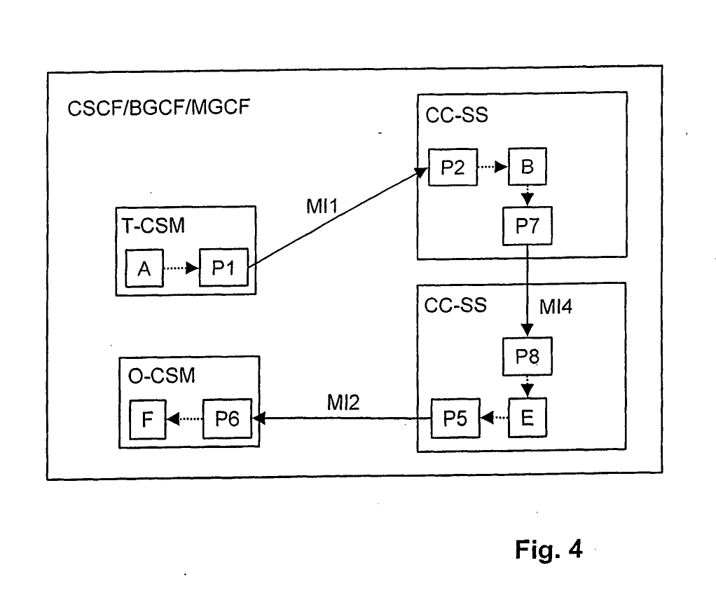

FIG. 4 shows a schematic block diagram according to a third embodiment. This embodiment differs from the second one in that the terminating CSM sends the signaling via an adapter process CC-SS to the originating CSM. At first, the terminating CSM sends a message MI1 to a first adapter process CC-SS. The message MI1 is received by a process P2 in the first CC-SS and the content of the data structure A is converted into a data structure B. Then, a message MI4 is sent from a process P7 in the first adapter process. The message MI4 carries the content of the data structure B to a data structure E in a second adapter process CC-SS, so that the content of E is substantially similar to a content of E if the message path was an external signaling path between adapter processes. The message MI4 is received at a process P8, where the FQDN of the network element corresponding to the functionality of the second adapter process may be added to a Record-Route header, but nothing may be added to the Via header. In the second CC-SS, a message MI2 is sent from a process P5 in the second adapter process to the originating CSM. The message MI2 is received at the process P6 in the originating CSM.

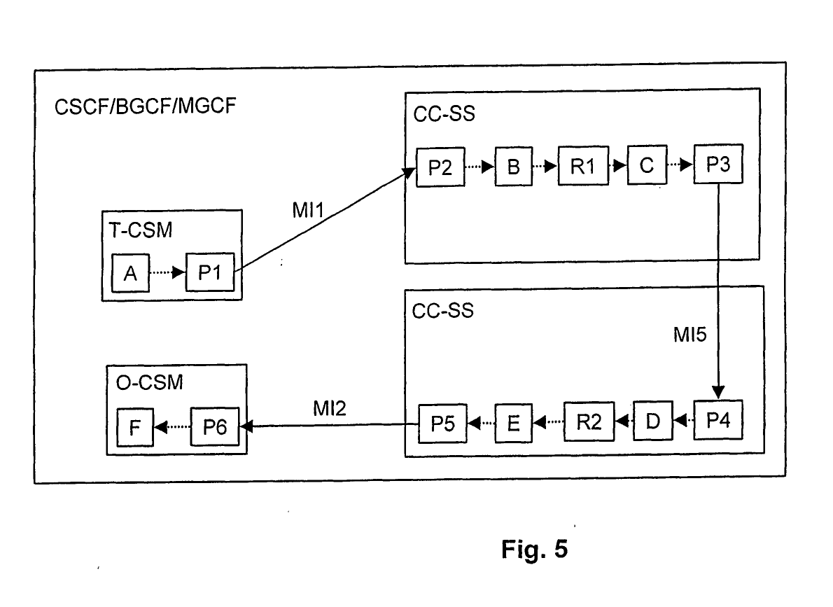

FIG. 5 shows a schematic block diagram according to a fourth embodiment. This embodiment differs from the third one in that also processing is performed in the adapter processes CC-SS. In the first adapter process, the data structure B is processed into a data structure C by a process R1. The content of the data structure C is then carried to a data structure D in the second adapter process by a message MI5, so that the content of D is substantially similar to a content of D if the message path was an external signaling path between adapter processes. A process P3 serves to send the message MI5, and a process P4 serves to receive the message MI5. At P4, the FQDN of the network element corresponding to the functionality of the second adapter process may be added to a Record-Route header, but nothing may be added to the Via header.

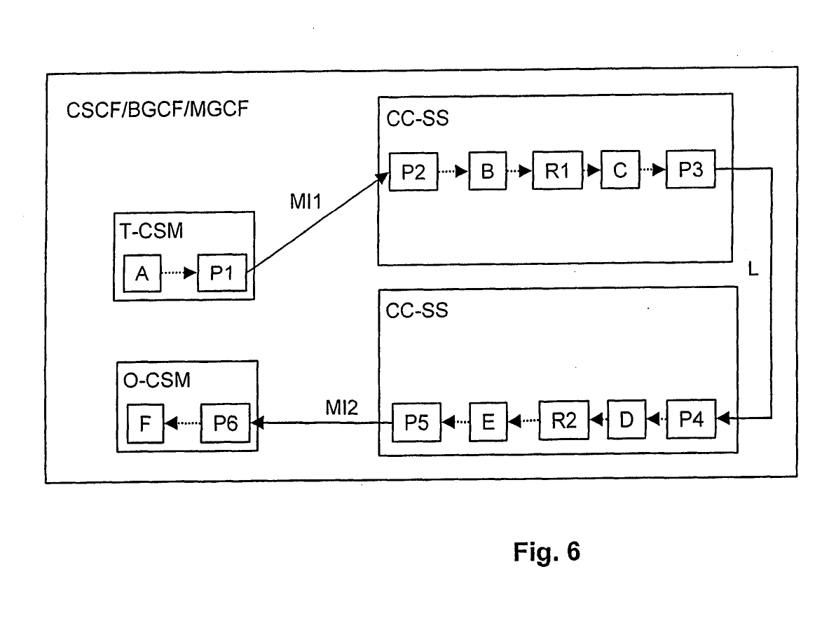

FIG. 6 shows a schematic block diagram according to a fifth embodiment. This embodiment differs from the fourth one in that the content of the data structure C is looped to the data structure D from the first adapter process to the second adapter process, so that the content of D is substantially similar to a content of D if the signaling path was an external path between logical network elements. In looping L, “localhost” hostname and/or loopback address are used. According to the fifth embodiment, the idea is to go down in the protocol stack from application and signaling protocol level to the lower levels and use a protocol there, e.g. UDP (User Datagram Protocol) or IP (Internet Protocol), to transfer the information from T-CSM to O-CSM without external route.

For example,
a) in the T-CSM the outgoing message goes down the protocol stack: SIP→UDP→IP,
b) the IP protocol finds out that the target address is the same physical network element and does not route the message out of the physical network element but puts it to the queue of incoming messages,
c) the message goes up the protocol stack in the O-CSM: IP→UDP→SIP.

In this example, the IP protocol finds out that the target is the same as the origin and does not send the message via external route.

At P4, the FQDN of the network element corresponding to the functionality of the second adapter process may be added to a Record-Route header, but nothing may be added to the Via header. The FQDN address is used in Record-Route and Via headers instead of the “localhost” hostname, and real IP address is used instead of the loopback IP address. However, if the usage of the “localhost” hostname and loopback IP address is insisted, the entry has to be swapped with the previous entry in the Via header.

Moreover, according to the fifth embodiment, some extra tasks have to be carried out at P6, when the message MI2 is received.

It is to be noted that the Via and Record-Route headers may be updated somewhere else than in P6, P8 and P4. When SIP is used as NNI protocol Via header and Record-Route header are normally updated. Via header is used to route the response back via the same route. Record-Route header is used to record the route in order to be used in the subsequent messages. Via and Record-Route headers can be handled at least in two ways. In the first way the address of each logical functionality on the route is inserted to the message as Via header as well as Record-Route header if it is used. If the Via header is utilized for the loop detection, identical addresses should be avoided in Via header because they indicate a loop. That is why the second way to handle Via header and Record-Route header is to add only one Via header and possibly one Record-Route header to the message so that the both headers contain the address of the physical network element instead of the logical functionalities included in the physical network element.

Furthermore, it is to be noted that according to the second embodiment and referring to FIGS. 3, 5 and 7, comparison on a substantial similarity is done between F which is obtained from A via P1→MI3→P6→F) and F which would be obtained from A via external routing, i.e. via P1→MI1→P2→B→R1→C→P3→external message ME1→P4→D→R2→E→P5→MI2→P6→F.

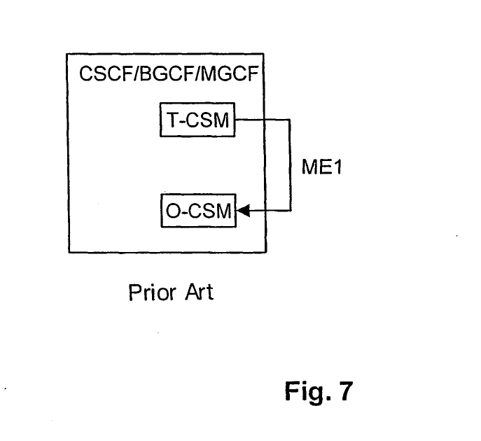

According to the third embodiment and referring to FIGS. 4, 5 and 7, comparison on a substantial similarity is done between E which is obtained from B via P7→MI4→P8→E, and E which would be obtained via external routing, i.e. via R1→C→P3→external message ME1 (shown in FIG. 7)→P4→D→R2→E.

Moreover, according to the third and fourth embodiments, in B and in E the data is not yet in the format of external signaling while in C and D it might be. One of the tasks of the adapter function CC-SS is to transform the internal signaling to external signaling and vice versa. This is depicted with R1 and R2.

According to the above described embodiments, at the process P6, also a correct CSM has to be selected. For this purpose, the message MI2 or MI3 can be used to indicate what service is required in the next network element. This indication may be deduced from the content of the message and/or from the format of the message and/or from the name of the message and/or from the type of the message and/or from the address of the message.

It is to be noted that in an embodiment there may also be just one call state model for each logical functionality. The originating and the terminating call state model could be combined into one call state model. In this embodiment, the functions related to the originating and the terminating call state model are combined into the unified call state model representing both the originating and the terminating side call processing tasks. Moreover, some of the logical functionalities may be stateless, i.e. there is no call state model or there is a call state model but it has only one state. Hence, according to the present invention, a call state model may be stateless or comprise at least two states. Or, in other words, a call state model has at least one or more states. For example, an I-CSCF may be transactionally statefull, i.e. stores the state only during the registration when it communicates with HSS (Home Subscriber Server).

Now, examples are given for the first to fifth embodiments. In these examples, the following assumptions are made:
1) Logical functionalities P-CSCF and S-CSCF are used here as example of the two logical functionalities that are located in the same network element called here P-CSCF/S-CSCF.
2) Originated and terminated call state models (i.e. O-CSM and T-CSM) of a logical functionality are separated.
3) SIP is used as NNI (Network to Network Interface) protocol i.e. as protocol that is used between network elements.
4) Originating call case where P-CSCF and S-CSCF are located in the same network is used as an example.
5) Combined CSM is only an example. It can include different combinations of O-CSM and T-CSM of P-CSCF and O-CSM and T-CSM of S-CSCF.
6) There are several methods how the decision can be done, whether the next logical functionality is located in the same network element or not. For example DNS resolving and/or deduction process based on the format and/or content and/or address of the message can be used.
7) There are several methods how the decision can be made, which logical functionality should be started when an NNI message is received in the network element that accommodates several logical functionalities. One method to distinguish the logical functionalities is to check the logical address of the message. For example pcscf.ims.sonera.fi should be taken care of by the P-CSCF logical functionality while scscf.ims.sonera.fi should be taken care of by the S-CSCF logical funtionality.
8) Every logical functionality that is located in the same network element may have its own call control signaling adaptation or have a common call control signaling adaptation with other logical functionalities.

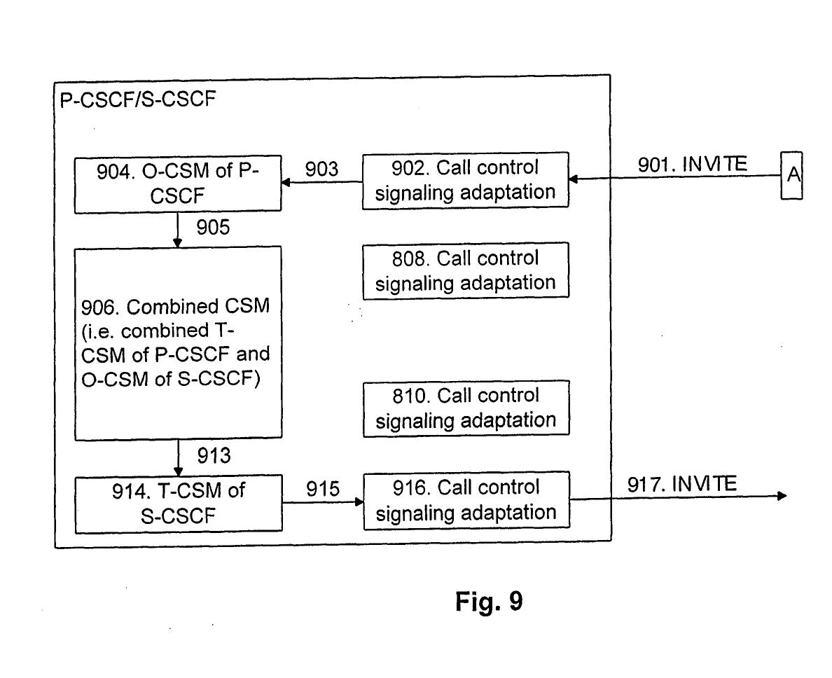

FIG. 9 shows an example of the solution according to the first embodiment, i.e. the combined CSM.

According to FIG. 9, in a step 901, an INVITE message is sent from a terminal A to the P-CSCF/S-CSCF. In a step 902, Call control signaling adaptation transforms the INVITE message to the internal format of the call control and stores it to an internal data structure. In a step 903, the content of the internal data structure is passed as data to an O-CSM of the P-CSCF. The O-CSM of the P-CSCF stores the data to an internal data structure and handles its content in a step 904.

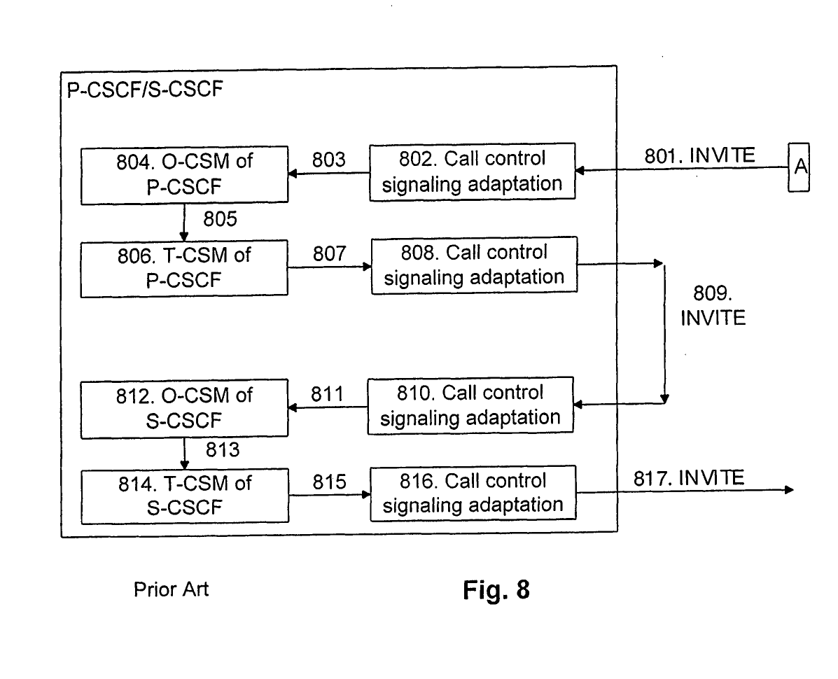

In a step 905, the O-CSM of the P-CSCF passes the control and the handled data in the internal data structure to the combined CSM. The combined CSM stores the data to an internal data structure and handles its content like a T-CSM of the P-CSCF in a step 906. A method is used to find out whether the next logical functionality is located in the same network element. For example, DNS resolving is done or addresses are compared. Because the next logical functionality is located in this same network element, combined CSM continues handling the data like an O-CSM of the S-CSCF instead of passing it to a call control signaling adaptation for outgoing messages (step 808 of FIG. 8.) The steps 807-812 of FIG. 8 are skipped in this case.

In a step 913, the combined CSM passes the control and the handled data in the internal data structure to a T-CSM of the S-CSCF. The T-CSM of the S-CSCF stores the data to an internal data structure and handles its content in a step 914. In a step 915, the content of the internal data structure is passed to Call control signaling adaptation. The Call control signaling adaptation stores the data to an internal data structure and transforms its content to an INVITE message in a step 916. For example, DNS resolving is used to find out the IP address of the next network element. In a step 917, an INVITE message is sent from the P-CSCF/S-CSCF to an I-CSCF via external routing.

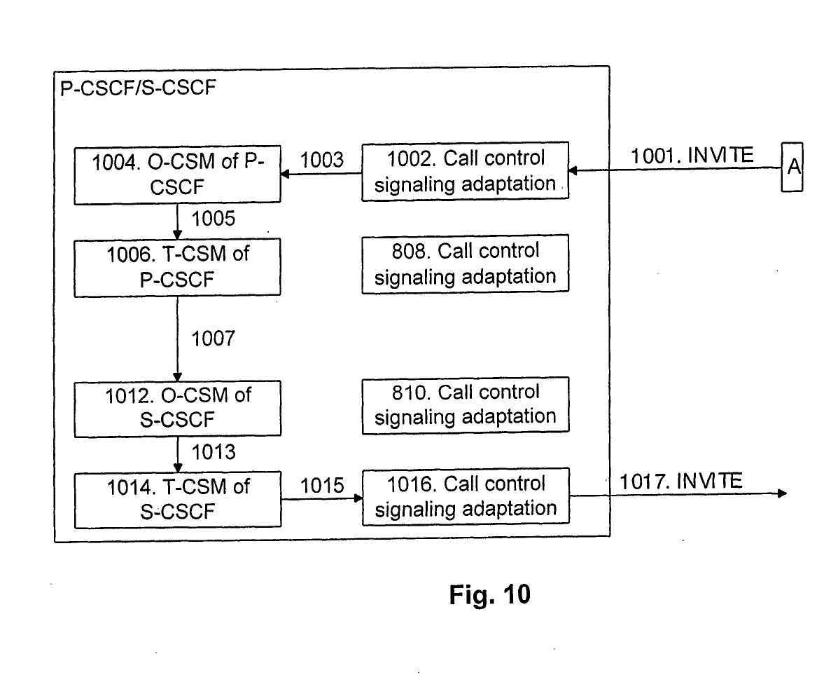

FIG. 10 shows an example of the solution according to the second embodiment.

According to FIG. 10, the steps 1001 to 1004 correspond to steps 901 to 904 of FIG. 9.

In a step 1005, an O-CSM of the P-CSCF passes the control and the handled data in the internal data structure to a T-CSM of the P-CSCF. The T-CSM of the P-CSCF stores the data to an internal data structure and handles its content in a step 1006. A method is used to find out whether the next logical functionality is located in the same network element. For example, DNS resolving is done or addresses are compared. Because the next logical functionality is located in this same network element, the T-CSM of the P-CSCF modifies the data if needed.

In a step 1007, the T-CSM of the P-CSCF passes the control and the modified data to an O-CSM of the S-CSCF instead of passing it to Call control signaling adaptation for outgoing messages (step 808 in FIG. 8). Steps 808-811 according to FIG. 8 are skipped in this case.

In a step 1012, the O-CSM of the S-CSCF stores the data to an internal data structure, modifies it if needed and handles its content. The O-CSM of the S-CSCF passes the control and the handled data in the internal data structure to a T-CSM of the S-CSCF in a step 1013. Steps 1014 to 1017 correspond to steps 914 to 917 in FIG. 9.

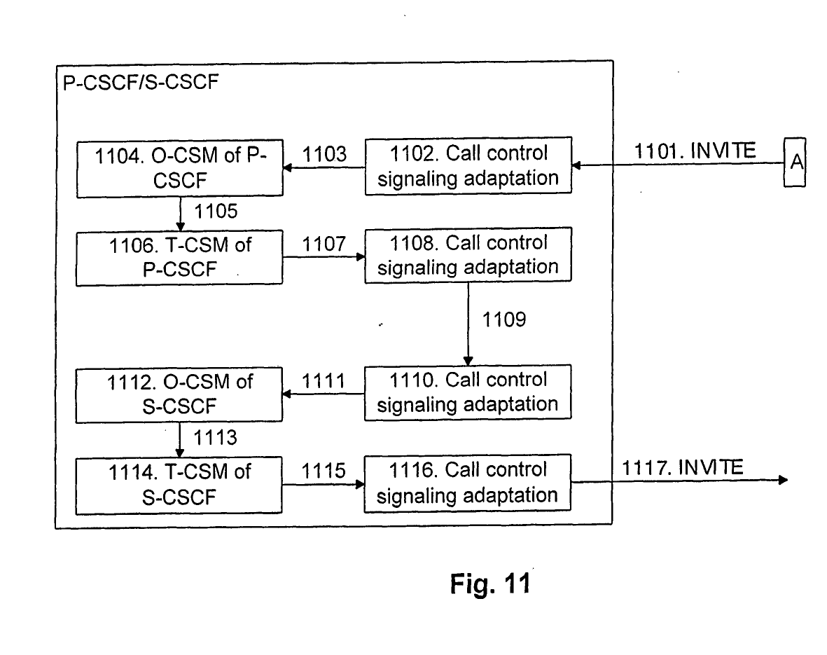

FIG. 11 shows an example for the solution according to the third embodiment.

According to FIG. 11, steps 1101 to 1105 correspond to steps 1001 to 1005 of FIG. 10. In a step 1106, the T-CSM of the P-CSCF stores the data to an internal data structure and handles its content. The content of the internal data structure is passed to Call control signaling adaptation in a step 1107. In a step 1108, the Call control signaling adaptation stores the data to an internal data structure, modifies it if needed and handles its content. A method is used to find out whether the next logical functionality is located in the same network element. For example, DNS resolving is done or addresses are compared. Because the next logical functionality is located in this same network element, the Call control signaling adaptation modifies the data if needed.

In a step 1109, the Call control signaling adaptation of the T-CSM of the P-CSCF passes the control and the modified data to the Call control signaling adaptation of an O-CSM of the S-CSCF instead of building a SIP message (INVITE) and sending it to the next network element via external routing. The Call control signaling adaptation of the O-CSM of the S-CSCF stores the data to an internal data structure, modifies it if needed and handles its content in a step 1110. In a step 1111, the content of the internal data structure is passed as data to the O-CSM of the S-CSCF. Steps 1112 to 1117 correspond to steps 1012 to 1017 of FIG. 10.

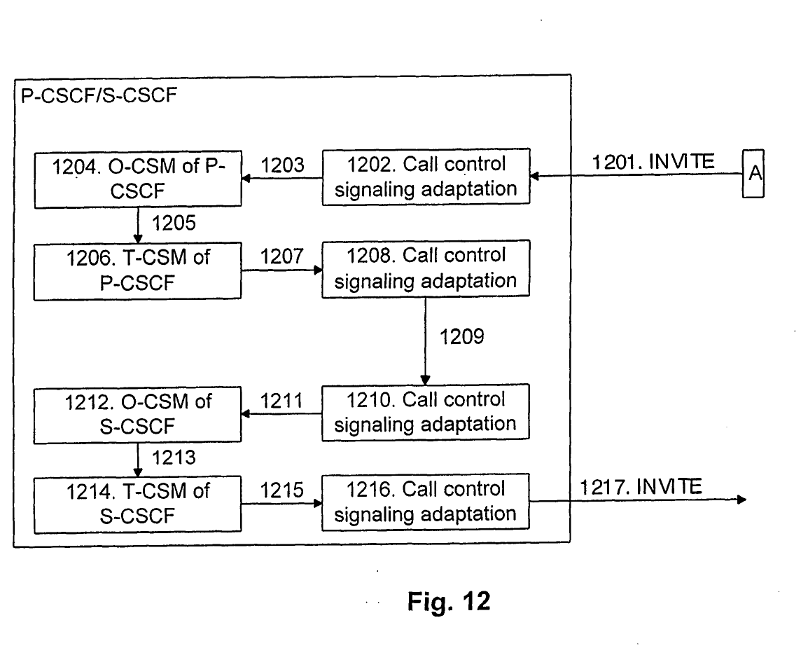

FIG. 12 shows an example of the solution according to the fourth embodiment.

According to FIG. 12, steps 1201 to 1207 correspond to steps 1101 to 1107 of FIG. 11. In a step 1208, the Call control signaling adaptation stores the data to an internal data structure, modifies it if needed, handles its content and transforms its content to an INVITE message. A method is used to find out whether the next logical functionality is located in the same network element. For example, DNS resolving is done or addresses are compared. Because the next logical functionality is located in this same network element, Call control signaling adaptation modifies the INVITE message if needed.

In a step 1209, Call control signaling adaptation of the T-CSM of the P-CSCF passes the control and the INVITE message to the Call control signaling adaptation of an O-CSM of the S-CSCF instead of sending it to the next network element via external routing. Call control signaling adaptation of the O-CSM of the S-CSCF transforms the INVITE message to the internal format of the call control and stores it to an internal data structure, modifies the data if needed and handles the content of the internal data structure in a step 1210. Steps 1211 to 1217 correspond to steps 1111 to 1117 of FIG. 11.

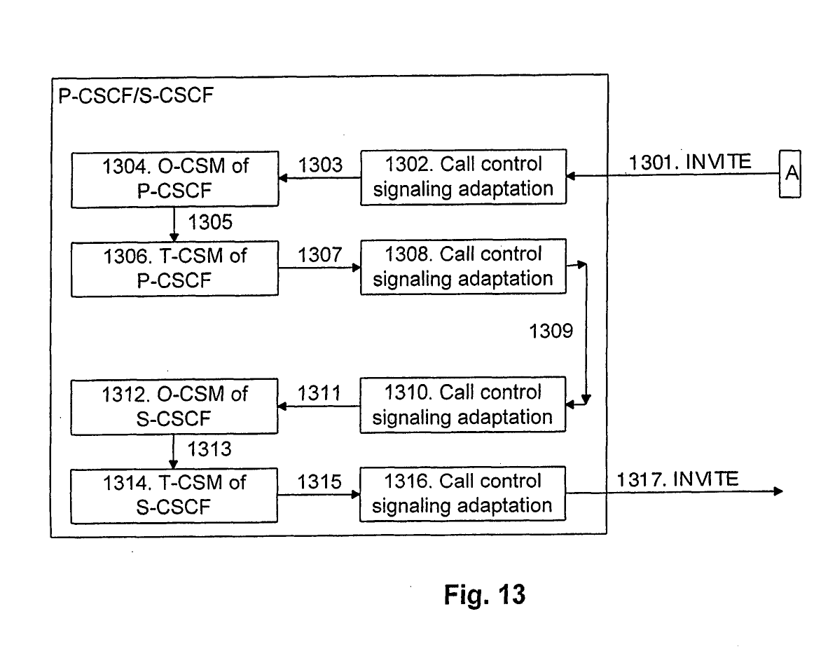

FIG. 13 shows an example of the solution according to the fifth embodiment.

According to FIG. 13, steps 1301 to 1308 correspond to steps 1201 to 1208 of FIG. 12. In step 1309, Call control signaling adaptation of the T-CSM of the P-CSCF passes the INVITE message down to the outgoing protocol stack. IP protocol level finds out that the target address is the same as the address of the current network element. IP protocol level doesn't send the message (i.e. the corresponding IP packets) to the external IP media but moves the message (or the corresponding IP packets) from the outgoing IP stack to the incoming IP stack.

In a step 1310, Call control signaling adaptation of an O-CSM of the S-CSCF receives the INVITE message (or the corresponding IP packets) from the incoming protocol stack and transforms the INVITE message to the internal format of the call control and stores it to an internal data structure, modifies the data if needed and handles the content of the internal data structure. Steps 1311 to 1317 correspond to steps 1111 to 1117 of FIG. 11.

While the invention has been described with reference to preferred embodiments, the description is illustrative of the invention and is not to be construed as limiting the invention. Various modifications and applications may occur to those skilled in the art without departing from the true spirit and scope of the invention as defined by the appended claims.

1. A method of routing a call between at least two logical network elements each performing a logical functionality on said call, said logical functionalities of said at least two logical network elements being accommodated in one physical control entity in an IP communication network system, said method comprising the steps of:
receiving a call at said physical control entity as a first logical functionality;
performing call-related processing in said physical control entity as said first logical functionality, thereby obtaining a content of a first data structure; and
invoking a second logical functionality in said physical control entity, wherein said content of said first data structure is supplied inside said physical control entity to a second data structure of said second logical functionality so that the content of said second data structure is substantially similar to a content obtained at the same stage in said second logical functionality by external routing between logical network elements.

2. A method according to claim 1, wherein said content of said first data structure is supplied within one call state model for a beginning of a functionality and an ending of a functionality.

3. A method according to claim 1, wherein said content of said first data structure is supplied by sending a message inside said physical control entity from a call state model for an ending of a functionality to a call state model for a beginning of a functionality.

4. A method according to claim 1, wherein said content of said first data structure is supplied by sending a first message from a call state model for an ending of a functionality to a first adapter process for translating said content of said first data structure to a data structure of an inter network element sending signaling, sending a second message from said first adapter process to a second adapter process for supplying said content of said inter network element sending signaling data structure to a data structure of an inter network element receiving signaling, so that the content of said inter network element receiving signaling data structure is substantially similar to a content obtained at the same stage in said second adapter process by external routing between logical network elements, and sending a third message from said second adapter process to a call state model for a beginning of a functionality, for translating said content of said inter network element receiving signaling data structure to said second data structure.

5. A method according to claim 1, wherein said content of said first data structure is supplied by sending a first message from a call state model for an ending of a functionality to a first adapter process for translating said content of said first data structure to a data structure of an inter network element sending signaling, performing processing on the content of said inter network element sending signaling data structure, thereby obtaining a content of a processed inter network element sending signaling data structure, sending a second message from said first adapter process to a second adapter process for supplying said content of said processed inter network element sending signaling data structure to a data structure of a processed inter network element receiving signaling, so that the content of said processed inter network element receiving signaling data structure is substantially similar to a content obtained at the same stage in said second adapter process by external routing between logical network elements, performing processing on said content of said processed inter network element receiving signaling data structure, thereby obtaining a content of an inter network element receiving signaling data structure and sending a third message from said second adapter process to a call state model for a beginning of a functionality, for translating said content of said inter network element receiving signaling data structure to said second data structure.

6. A method according to claim 1, wherein said content of said first data structure is supplied by sending a first message from a call state model for an ending of a functionality to a first adapter process for translating said content of said first data structure to a data structure of an inter network element sending signaling, performing processing on the content of said inter network element sending signaling data structure, thereby obtaining a content of a processed inter network element sending signaling data structure, performing looping from said first adapter process to a second adapter process via a protocol level below the used signaling protocol between network elements for supplying said content of said processed inter network element sending signaling data structure to a data structure of a processed inter network element receiving signaling, so that the content of said processed inter network element receiving signaling data structure is substantially similar to a content obtained at the same stage in said second adapter process by external routing between logical network elements, performing processing on said content of said processed inter network element receiving signaling data structure, thereby obtaining a content of an inter network element receiving signaling data structure and sending a third message from said second adapter process to a call state model for a beginning of a functionality, for translating said content of said inter network element receiving signaling data structure to said second data structure.

7. A method according to claim 3, wherein, when said message is received at said call state model for a beginning of a functionality, an identification of the logical network element performing said second logical functionality is added to a record-route field in said message.

8. A method according to claim 3, wherein, when said message is received at said call state model for a beginning of a functionality, no identification of the logical network element performing said second logical functionality is added to a field of said message, which indicates a path taken by a request so far.

9. A method according to claim 4, wherein, when said second message is received, an identification of the logical network element performing said second logical functionality is added to a record-route field in said second message.

10. A method according to claim 4, wherein, when said second message is received, no identification of the logical network element performing said second logical functionality is added to a field of said second message, which indicates a path taken by a request so far.

11. A method according to claim 6, wherein, when performing looping from said first adapter process to said second adapter process, an identity of a local host and/or a loopback address are used.

12. A method according to claim 6, wherein, when the looped content is received at said second adapter process, an identification of the logical network element performing said second logical functionality is added to a record-route field in said looped content.

13. A method according to claim 6, wherein, when the looped content is received at said second adapter process, no identification of the logical network element performing said second logical functionality is added to a field of said looped content, which indicates a path taken by a request so far.

14. A method according to claim 6, wherein, when the looped content is received at said second adapter process, a previous entry of a record-route field in said looped content is used as identification of the logical network element performing said second logical functionality in said record-route field.

15. A method according to claim 3, wherein in the message supplied to said call state model for a beginning of a functionality a service required in the next network element is indicated.

16. A method according to claim 3, wherein the internal messages are call control protocol messages.

17. A method according to claim 1, wherein it is determined by said first logical functionality whether the second logical functionality can be invoked at the same physical control entity by analyzing destination information for the call.

18. A method according to claim 17, wherein said first logical functionality is a serving call state control function of an IP multimedia system.

19. A method according to claim 17, wherein said second logical functionality is an interrogating call state control function of an IP multimedia system.

20. A method according to claim 17, wherein said first logical functionality is a proxy call state control function of an IP multimedia system.

21. A method according to claim 17, wherein said second logical functionality is a serving call state control function of an IP multimedia system.

22. A method according to claim 17, wherein the destination information for the call comprises an FQDN.

23. A method according to claim 17, wherein the destination information for the call comprises the IP-address obtained by performing a DNS resolution procedure for at least part of a target identification.

24. A method according to claim 23, wherein the identification comprises an FQDN.

25. A control entity for routing a call between at least two logical network elements each performing a logical functionality on said call, said logical functionalities of said at least two logical network elements being accommodated in said control entity in an IP communication network system, said control entity being arranged to:
receiving a call as a first logical functionality;
performing call-related processing as said first logical functionality, thereby obtaining a content of a first data structure; and
invoking a second logical functionality,
wherein said content of said first data structure is supplied inside said control entity to a second data structure of said second logical functionality so that the content of said second data structure is substantially similar to a content obtained at the same stage in said second logical functionality by external routing between logical network elements.

26. A control entity according to claim 25, comprising one call state model for a beginning of a functionality and an ending of a functionality, wherein said content of said first data structure is supplied within said one call state model.

27. A control entity according to claim 25, comprising;
a call state model for an ending of a functionality; and
a call state model for a beginning of a functionality,
wherein said content of said first data structure is supplied by sending a message from said call state model for an ending of a functionality to said call state model for a beginning of a functionality.

28. A control entity according to claim 25, comprising:
a call state model for an ending of a functionality;
a call state model for a beginning of a functionality;
a first adapter process communicating with said call state model for an ending of a functionality; and
a second adapter process communicating with said call state model for a beginning of a functionality,
wherein, for supplying said content of said first data structure, said call state model for an ending of a functionality sends a first message to said first adapter process for translating said content of said first data structure to a data structure of an inter network element sending signaling, said first adapter process sends a second message to said second adapter process for supplying said content of said inter network element sending signaling data structure to a data structure of an inter network element receiving signaling, so that the content of said inter network element receiving signaling data structure is substantially similar to a content obtained at the same stage in said second adapter process by external routing between logical network elements, and said second adapter process sends a third message to said call state model for a beginning of a functionality, for translating said content of said inter network element receiving signaling data structure to said second data structure.

29. A control entity according to claim 25, comprising:
a call state model for an ending of a functionality;
a call state model for a beginning of a functionality;
a first adapter process communicating with said call state model for an ending of a functionality; and
a second adapter process communicating with said call state model for a beginning of a functionality,
wherein, for supplying said content of said first data structure, said call state model for an ending of a functionality sends a first message to said first adapter process for translating said content of said first data structure to a data structure of an inter network element sending signaling, said first adapter process performs processing on the content of said inter network element sending signaling data structure, thereby obtaining a content of a processed inter network element sending signaling data structure, and sends a second message to said second adapter process for supplying said content of said processed inter network element sending signaling data structure to a data structure of a processed inter network element receiving signaling, so that the content of said processed inter network element receiving signaling data structure is substantially similar to a content obtained at the same stage in said second adapter process by external routing between logical network elements, said second adapter process performs processing on said content of said processed inter network element receiving signaling data structure, thereby obtaining a content of an inter network element receiving signaling data structure, and sends a third message to said call state model for a beginning of a functionality, for translating said content of said inter network element receiving signaling data structure to said second data structure.

30. A control entity according to claim 25, comprising:
a call state model for an ending of a functionality;
a call state model for a beginning of a functionality;
a first adapter process communicating with said call state model for an ending of a functionality; and
a second adapter process communicating with said call state model for a beginning of a functionality,
wherein, for supplying said content of said first data structure, said call state model for an ending of a functionality sends a first message to said first adapter process for translating said content of said first data structure to a data structure of an inter network element sending signaling, said first adapter process performs processing on the content of said inter network element sending signaling data structure, thereby obtaining a content of a processed inter network element sending signaling data structure, and performs looping to said second adapter process via a protocol level below the used signaling protocol between network elements for supplying said content of said processed inter network element sending signaling data structure to a data structure of a processed inter network element receiving signaling, so that the content of said processed inter network element receiving signaling data structure is substantially similar to a content obtained at the same stage in said second adapter process by external routing between logical network elements, said second adapter process performs processing on said content of said processed inter network element receiving signaling data structure, thereby obtaining a content of an inter network element receiving signaling data structure, and sends a third message to said call state model for a beginning of a functionality, for translating said content of said inter network element receiving signaling data structure to said second data structure.

31. A control entity according to claim 27, wherein, when said call state model for a beginning of a functionality receives said message, said control entity adds an identification of the logical network element performing said second logical functionality to a record-route field in said message.

32. A control entity according to claim 27, wherein, when said call state model for a beginning of a functionality receives said message, said control entity adds no identification of the logical network element performing said second logical functionality to a field of said message, which indicates a path taken by a request so far.

33. A control entity according to claim 28, wherein, when said second message is received, said control entity adds an identification of the logical network element performing said second logical functionality to a record-route field in said second message.

34. A control entity according to claim 28, wherein, when said second message is received, said control entity adds no identification of the logical network element performing said second logical functionality to a field of said second message, which indicates a path taken by a request so far.

35. A control entity according to claim 30, wherein, when said first adapter process performs looping to said second adapter process, said control entity uses an identity of a local host and/or a loopback address.

36. A control entity according to claim 30, wherein, when said second adapter process receives the looped content, said control entity adds an identification of the logical network element performing said second logical functionality to a record-route field in said looped content.

37. A control entity according to claim 30, wherein, when said second adapter process receives the looped content, said control entity adds no identification of the logical network element performing said second logical functionality to a field of said looped content, which indicates a path taken by a request so far.

38. A control entity according to claim 30, wherein, when said second adapter process receives the looped content, said control entity uses a previous entry of a record-route field in said looped content as identification of the logical network element performing said second logical functionality in said record-route field.

39. A control entity according to claim 27, wherein said control entity indicates, in the message supplied to said call state model for a beginning of a functionality, a service required in the next network element.

40. A control entity according to claim 27, wherein the internal messages are call control protocol messages.

41. A control entity according to claim 25, wherein said first logical functionality determines whether the second logical functionality can be invoked at the same physical control entity by analyzing destination information for the call.

42. A control entity according to claim 41, wherein said first logical functionality is a serving call state control function of an IP multimedia system.

43. A control entity according to claim 41, wherein said second logical functionality is an interrogating call state control function of an IP multimedia system.

44. A control entity according to claim 41, wherein said first logical functionality is a proxy call state control function of an IP multimedia system.

45. A control entity according to claim 41, wherein said second logical functionality is a serving call state control function of an IP multimedia system.

46. A control entity according to claim 41, wherein the destination information for the call comprises an FQDN.

47. A control entity according to claim 41, wherein the destination information for the call comprises the IP-address obtained by performing a DNS resolution procedure for at least part of a target identification.

48. A control entity according to claim 47, wherein the identification comprises an FQDN.
